(19) United States
(12) Patent Application Publication
(10) Pub. No.: US 2025/0256754 A1
(43) Pub. Date: Aug. 14, 2025

(54) CANOPY ROTATION STRUCTURES CONFIGURED FOR GRASPING

(71) Applicant: Evenflo Company Inc., Miamisburg, OH (US)

(72) Inventor: Gaylen ERCANBRACK, Miamisburg, OH (US)

(21) Appl. No.: 18/436,944

(22) Filed: Feb. 8, 2024

(51) Int. Cl. B62B 9/14

(52) U.S. Cl. CPC B62B 9/142

(57) ABSTRACT

Embodiments of the present disclosure are directed to a canopy rotation structure that may be removably coupled to a child transport product. The canopy rotation structures generally comprise a first arch and a second arch, each of which attach to canopy wings and rotate relative to each other. The first arch may at least partially define an opening that a user may grasp during use or during collapse of the child transport product.

### BACKGROUND

Child transport products such as wagons and strollers can be used to transport children, their affects, and other items. Child transport products often include a canopy affixed to the product to provide cover from the sun, the rain, or other elements. Child transport products are also frequently collapsible for ease of storage. For example, in a collapsed position, the child transport product may be folded up into a product that takes up less space than when in an expanded position. The product may be pulled into an expanded, use position by a user pulling an area of the product to expand the product. Some child transport products may include a designated handle or pull piece that is separate from existing structures for the user to use to expand the child transport product.

### BRIEF DESCRIPTION OF THE DRAWINGS

The present disclosure is described in detail below with reference to these figures.

FIG. 1 illustrates a perspective view of a child transport product with a canopy in accordance with an embodiment disclosed herein.

FIGS. 2A-2B illustrate a front view of a user expanding the child transport product of FIG. 1 between a partially collapsed position and an expanded position with assistance of canopy rotation structures in accordance with an embodiment disclosed herein.

FIG. 3 illustrates a perspective view of the canopy from FIG. 1 in accordance with an embodiment disclosed herein.

FIGS. 4A-4C illustrate various views of one of the canopy rotation structures from FIG. 2 in accordance with an embodiment disclosed herein.

FIG. 5 illustrates a perspective view of another canopy rotation structure in accordance with an embodiment disclosed herein.

### DETAILED DESCRIPTION

As briefly discussed above, child transport products are often collapsible. Generally, users may be able to directly grasp the frame of the child transport product to move the product between configurations (e.g., moving from a collapsed configuration to an expanded configuration). However, the frame, which may often be a cylindrical rod and sometimes is covered by soft goods, may not be easy or comfortable to grasp. A child transport product may include additional structures, such as handles, that may be provided solely for the purposes of grasping when a user is expanding the child transport product. Yet, these typically involve manufacturing a separate piece. As such, it can be useful for a child transport product to incorporate a feature for user grasping to increase user comfort and ease of use when moving the product from a collapsed configuration to an expanded configuration, and by incorporating such a grasping feature into an existing structure, a less redundant and more efficient child transport product may be provided.

This detailed description is related to a canopy rotation structure that may be coupled to a child transport product or apparatus (e.g., a wagon or stroller) that may be grasped by the user to assist in expanding the child transport product from a collapsed position. In some examples, a canopy is coupled to a child transport product by attaching a first and a second canopy rotation structure on each side of the frame. At least one of the first and second canopy rotation structures, and in some embodiments, each of the canopy rotation structures, includes an opening through which a user can insert at least part of the user's hand for grasping.

The canopy rotation structure may include a first and a second arch that are rotatable relative to each other. The first arch attaches to a first canopy wing, and the second arch attaches to a second canopy wing. The first and second canopy wings may include a textile or soft good extending between the first and second canopy wing. In this way, the first and second arches may be rotated to adjust the angle of protection provided by the canopy textile or expand or contract the canopy textile. Further, at least the first arch may define an opening configured for grasping by a user to assist in expanding the product from a collapsed position. In some examples, the opening may be a through hole extending between the first and the second arches, and in other examples, the opening may be an indentation that extends at least partially through the first arch. In some embodiments, a central arch is positioned between the first arch and the second arch, and the central arch is configured to be attached to the child transport product.

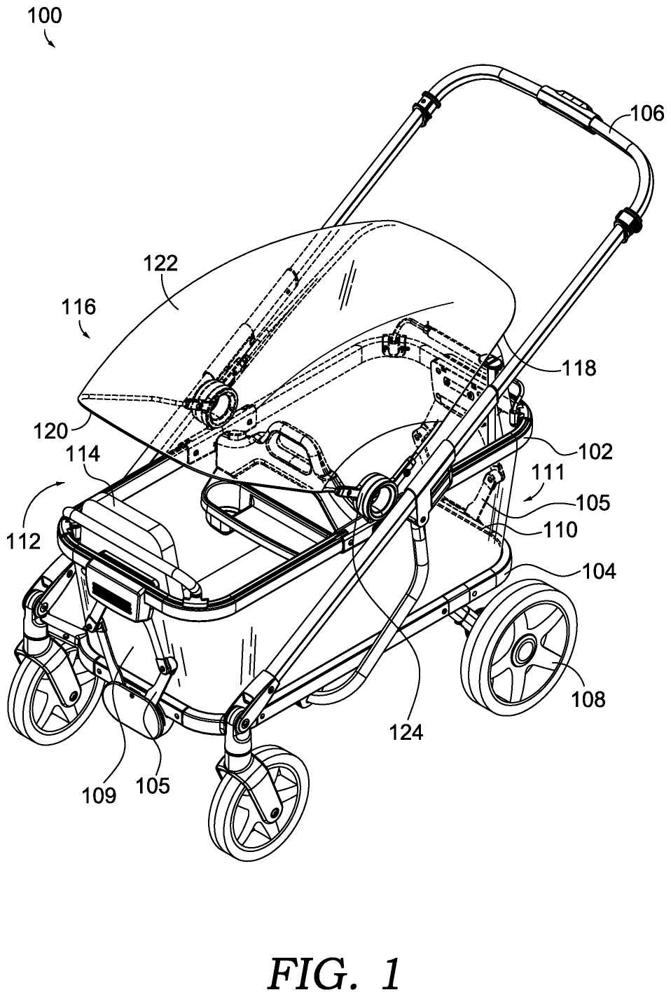

Turning now to FIG. 1, an example child transport product 100 is provided. FIG. 1 illustrates a wagon as an example child transport product 100, but it should be appreciated that the components of the child transport product 100 described herein can be in the form of other types of wheeled carriers, including a stroller.

The child transport product 100 may generally comprise a frame that generally defines a first side 110, a second side 112 generally opposite the first side 110, a front side 109, and a rear side 111 generally opposite the front side 109. The frame may include a first frame portion 102 and a second frame portion 104. In some embodiments, such as the child transport product 100 of FIG. 1, the first frame portion 102 may be a top frame portion and the second frame portion 104 may be a bottom frame portion, where the first frame portion 102 and the second frame portion 104 may each extend around the front side 109, the first side 110, the rear side 111, and the second side 112. Further, as depicted in FIG. 1, the first frame portion 102 may be separated from the second frame portion 104 such that they are not directly coupled together. In instances, the child transport product 100 includes one or more side frame portions 105 that extend between the first frame portion 102 and the second frame portion 104 on one or more sides of the child transport product 100. In one example, the child transport product 100 includes side frame portions 105 on the front and rear sides 109 and 111 of the frame.

In other embodiments, the first frame portion 102 and the second frame portion 104 may be positioned in a variety of orientations. For example, in another wagon embodiment, the first frame portion 102 may be a front frame portion that extends on the front side 109 and portions of the first side 110 and second side 112, and the second frame portion 104 may be a rear frame portion that extends on the rear side 111 and portions of the first side 110 and second side 112. In one example of a stroller embodiment of the present disclosure, the first frame portion 102 may be coupled to the second frame portion 104 to form a variety of angles between them. For instance, the first frame portion 102 may comprise a push handle and at least top portion of stroller side rails while the second frame portion 104 may comprise stroller legs. Additionally, the first frame portion 102 and the second frame portion 104 may be portions of a unitary structure or may be separately formed structures secured together either directly or indirectly via other components, such as the side frame portion(s) 105.

A handle 106 may be attached to the child transport product 100. The handle 106 is arranged at the rear of the frame in this example and may act as a push handle. In other aspects, the handle 106 may be arranged at the front of the child transport product 100 so that it may be used as a pull handle. In some aspects, the handle 106 may be adjustable so that it is movable between the front side 109 and the rear side 111 of the frame so that it may be used for push or pull. The handle may be movable relative to the frame through sliding, rotating, telescoping, pivoting, and the like. The handle 106 may be composed of two side handle portions and a central handle portion that connects the two side handle portions and provides a central area where a user would grasp the handle 106. In other examples, the handle 106 may comprise two side handle portions that are not joined together.

The frame may be coupled to wheels 108 allowing movement of the child transport product 100. The wheels 108 are located at least partially under the frame such that the wheels support the weight of the frame. While four wheels 108 are shown, it will be appreciated that additional or fewer wheels 108 may be provided. For example, the child transport product 100 may have a three-wheel configuration. The wheels 108 may be uniform in size or there may be differences in wheel sizes. For example, the rear wheels 108 may be larger in diameter than the front wheels 108.

Between the first side 110 and the second side 112 of the frame may be a seating area 114 configured to accommodate a person, such as a child. The seating area 114 is generally positioned above the wheels 108. The seating area 114 may include soft goods, such as textiles and cushions, to aid in occupant comfort. The seating area 114 may also include a harness, lap belt, or other features not illustrated.

The child transport product 100 may also include a canopy 116 generally comprising a first canopy wing 118, a second canopy wing 120, and a canopy textile 122 extending between the first canopy wing 118 and the second canopy wing 120. FIG. 1 shows the canopy 116 expanded such that the canopy textile 122 is positioned over some of the other canopy 116 structures described herein, which may obstruct the view shown in FIG. 1. As such, these structures are shown in dashed line in FIG. 1, indicating that they are present but would be obscured by the canopy textile 122.

Generally, the canopy 116 provides protection or shade from the sun or other elements like rain, snow, or wind. The canopy 116 may also provide privacy to occupants or users of the child transport product 100, such as children. Further, the canopy 116 may provide a sense of security to occupants by providing a more enclosed space. The canopy 116 may increase safety as the canopy 116 can discourage occupants from reaching outside of the child transport product 100. While the canopy 116 in FIG. 1 is shown as a single canopy 116 positioned in the center of the frame, it is expressly contemplated that additional canopies 116 may be coupled to the frame, and the canopy or canopies 116 may be positioned in an area other than the center of the frame.

The canopy textile 122 may be formed of various textiles, plastics, combinations of materials, and the like. In some embodiments, the canopy textile 122 may filter or be resistant to ultraviolet (UV) rays that attempt to penetrate the canopy textile 122. The canopy textile 122 may be at least partially composed of a mesh material to allow for breathability within the child transport product 100. The canopy textile 122 may also be water-resistant or have a waterproof coating such that rain or snow does not penetrate through the canopy and reach the occupant. The canopy textile 122 may be composed of elasticized material or thread such that the canopy textile 122 can securely attach to the first canopy wing 118 and the second canopy wing 120. The canopy textile 122 may be removable, such as via hook and loop fasteners, snaps, buttons, drawstrings, zipper, a combination of these, and/or the like, from the first canopy wing 118 and the second canopy wing 120 so a user may wash and clean the canopy textile 122.

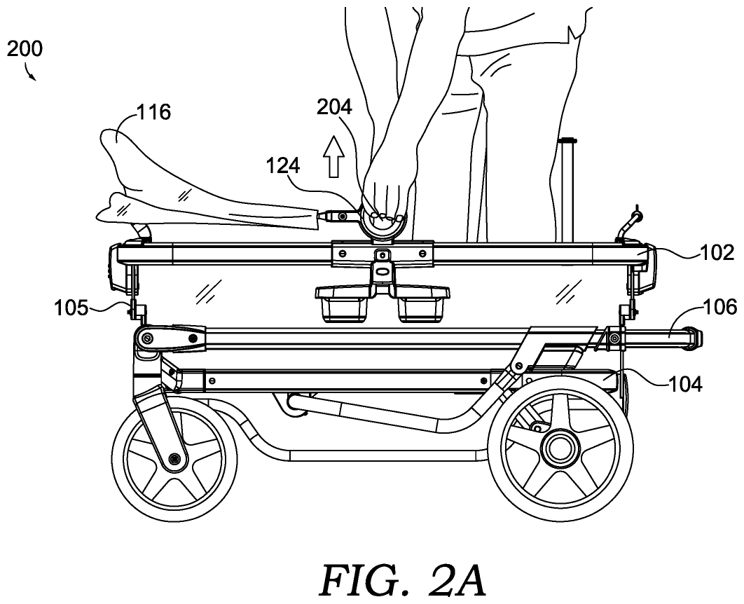

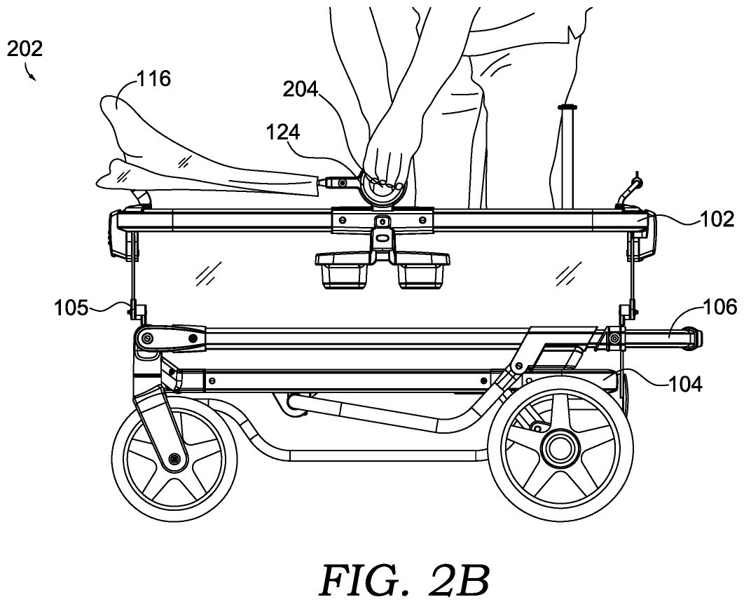

The first canopy wing 118 and the second canopy wing 120 are configured to support the canopy textile 122 when the canopy 116 is in a use position (as compared to the canopy 116 in a collapsed position as shown in FIGS. 2A-2B) and enable movement and adjustment of the canopy textile 122. The first canopy wing 118 and the second canopy wing 120 are rotatable relative to the frame portions, each other, or a combination of these. The first canopy wing 118 and the second canopy wing 120 may be positioned to create different angles relative to each other to provide customized weather protection. For example, the first canopy wing 118 and the second canopy wing 120 may be rotated to have a smaller angle between each other such that the canopy textile 122 is not completely expanded and less shade is provided. In some embodiments, the first canopy wing 118 and the second canopy wing 120 may have a lock that secures a particular use angle into place such that the occupant cannot manually adjust the canopy without unlocking the lock. The first canopy wing 118 and the second canopy wing 120 may be collapsed by rotating the first canopy wing 118 and the second canopy wing 120 toward the first frame portion 102, either towards the front side 109 or the rear side 111. The first canopy wing 118 and the second canopy wing 120 may rest adjacent to the first frame portion 102 when the canopy 116 is collapsed, as shown in FIG. 2A-2B. The first canopy wing 118 and the second canopy wing 120 may be formed of a variety of materials such as steel, aluminum, carbon fiber, titanium, plastics, and the like.

The child transport product 100 includes canopy rotation structures 124 coupled to the first canopy wing 118 and the second canopy wing 120 that allow the first canopy wing 118 and the second canopy wing 120 to rotate relative to each other and/or the frame portions. The canopy rotation structures 124 may be positioned on the first and second sides 110 and 112 of the child transport product 100. As such, the canopy rotation structures 124 may be referred to herein as a first canopy structure and a second canopy structure and may be mirror images of each other unless otherwise indicated. The canopy rotation structures 124 attach the first canopy wing 118 and the second canopy wing 120 to the frame of the child transport product 100 by nuts, bolts, screws, spring loaded pins, twisting locks, welding, and the like. Various attachment mechanisms will be appreciated by those skilled in the art. In other embodiments, the first canopy wing 118 and/or the second canopy wing 120 and at least some components of the canopy rotation structures 124 are an integrated piece.

The canopy rotation structures 124 may be removable from the frame such that the canopy 116 is removably coupled to the child transport product 100. The canopy rotation structures 124 may be removably coupled to the first frame portion 102. In other embodiments where the first and second frame portions 102 and 104 do not form top and bottom frame portions, the canopy rotation structures 124 may be removably coupled to the first frame portion 102, the second frame portion 104, or a combination of these. The canopy rotation structures 124 may be removably coupled to the frame of the child transport product 100 via sliding connections, spring loaded pins, latches, hook and loop fasteners, and the like. One skilled in the art will appreciate additional coupling mechanisms known in the art.

In some embodiments, the child transport product 100 is collapsible between a collapsed position 200 and a use position 202, as shown in FIGS. 2A-2B. The collapsed position 200 may be a position in which the child transport product could be stored in the back of a vehicle or a closet, for example. The use position 202 may be a position in which the child transport product 100 could be pushed or pulled carrying an occupant, such as a child. In other examples, the child transport product 100 is not collapsible.

Now turning to FIGS. 2A and 2B, the collapsed position 200 and the use position 202 are provided. The first frame portion 102 is movable relative to a second frame portion 104 such that a user may pull on the first frame portion 102 to expand the child transport product 100 from the collapsed position 200 to the use position 202. In some aspects, the first frame portion 102 and the second frame portion 104 may be a top frame and a bottom frame, and the top frame may be movable relative to the bottom frame. In other aspects, the first frame portion 102 may be a left frame and the second frame portion 104 may be a right frame, and the left frame may be movable relative to the right frame. In other aspects, the first frame portion 102 may be attached to the second frame portion 104 at a variety of angles, such as in a stroller configuration. The first frame portion 102 may be movable relative to the second frame portion 104, or vis-versa, through sliding, rotating, telescoping, pivoting, and the like. In the example depicted in FIGS. 2A and 2B, the side frame portions 105 may each include a plurality of links that rotate relative to each other to move the first frame portion 102 relative to the second frame portion 104, thereby collapsing and expand the child transport product 100. While generally described as one frame portion being movable relative to the other, it is expressly contemplated that both the first frame portion 102 and the second frame portion 104 may both be movable relative to each other.

The canopy rotation structures 124 may include an opening 204 configured to receive a user grasp to assist in transforming the child transport product 100 between the collapsed position 200 and the use position 202 and/or vice versa. For example, the user may need to expand the collapsed position 200 into a use position 202 to prepare for an occupant, such as a child, after removing the child transport product 100 out of storage. The user may grasp the opening 204 to pull on the frame (e.g., the first frame portion 102) to expand the child transport product 100. Additionally, for both embodiments of the child transport product 100 that are collapsible and embodiments that are not collapsible, the opening 204 of the canopy rotation structures 124 may be used to lift or carry the child transport product 100 when positioned in the use position 202. For example, a user may need to lift the child transport product 100 up a flight of stairs or onto another raised surface and may lift the child transport product in the use position 202 by grasping the openings 204 of the canopy rotation structures 124.

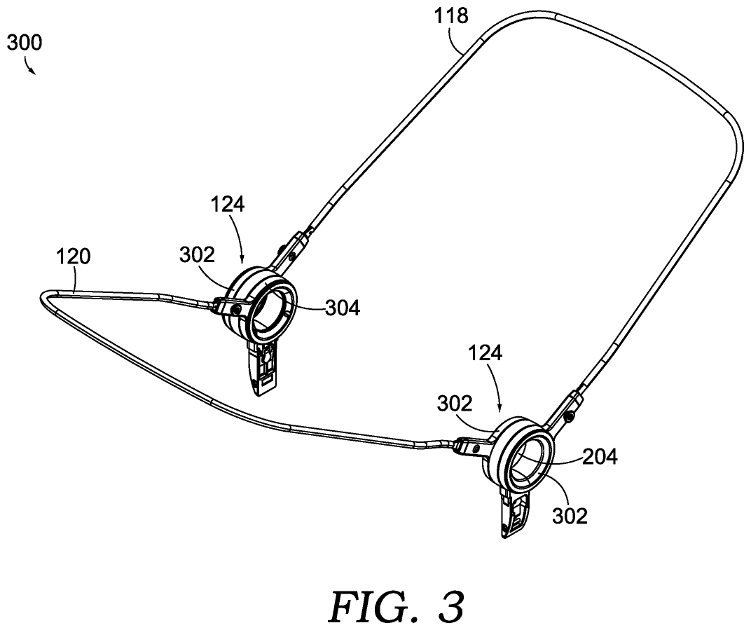

Turning now to FIG. 3, an embodiment of the canopy rotation structures 124 is provided. Canopy rotation structures 124 allow for the canopy 116 to collapse such that the child transport product 100 can more compactly collapse into a smaller structure suitable for storage and/or to temporarily remove the shade/protection provided by the canopy 116 or to adjust the angle of the canopy 116. The canopy rotation structures 124 may each generally comprise a first arch 302 and a second arch 304. The first arch 302 and the second arch 304 of each canopy rotation structure 124 are coupled to the canopy wings 118, 120 such that each of the first arches 302 couple to the first canopy wing 118 and each of the second arches 304 couple to the second canopy wing 120. The first arch 302 on at least one canopy rotation structure 124 may define the opening 204, or in some embodiments, the first arch 302 on both canopy rotation structures 124 defines the opening 204 configured for grasping such that the user can comfortably expand, collapse, lift, and/or carry the child transport product 100 evenly through both the first side 110 and the second side 112. In this example, the opening 204 is a through hole, but in other embodiments, the opening 204 may be an indentation extending at least partially through the first arch 302. While FIG. 3 shows each canopy rotation structure 124 having an opening 204 (for two openings 204 combined), it is expressly contemplated that only one canopy rotation structure 124 may have an opening 204.

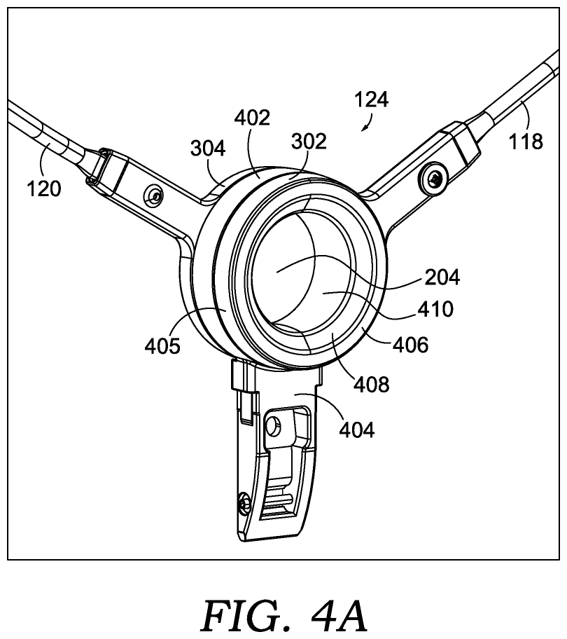

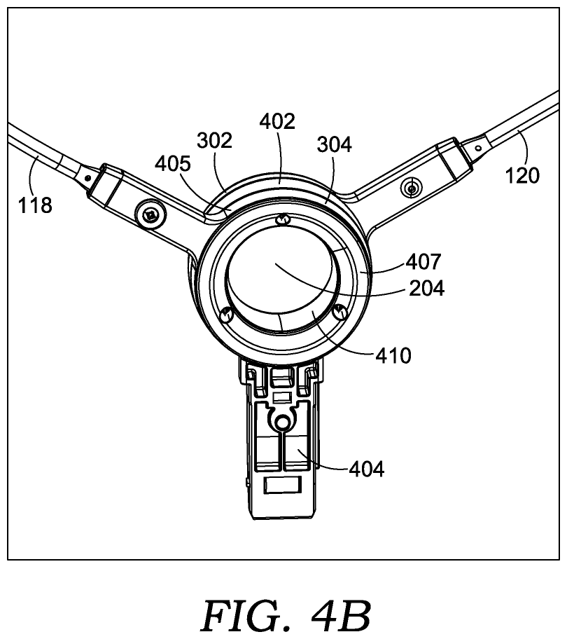

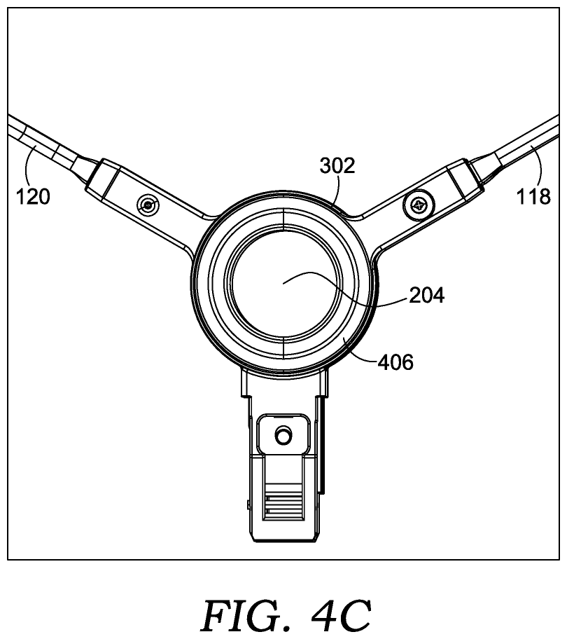

As shown in FIGS. 4A-4C, the first arch 302 and the second arch 304 may be contiguously arranged in a horizontal orientation. In some embodiments, the first arch 302 and the second arch 304 are horizontally arranged contiguous to each other such that the first arch 302 is juxtaposed to the second arch 304. In other embodiments, such as the one shown in FIGS. 4A-4C, the first arch 302 and the second arch 304 are arranged horizontally and are each juxtaposed to a central arch 402 such that the central arch 402 is contiguously arranged in a horizontal orientation between the first arch 302 and the second arch 304.

The first arch 302 and the second arch 304 are configured to allow for rotation of each arch relative to the other, such as to expand or collapse the canopy 116. For example, when the first canopy wing 118 (which is attached to each first arch 302) experiences a force, each of the first arches 302 may rotate in response. Similarly, for example, when the second canopy wing 120 (which is attached to each second arch 304) experiences a force, each of the second arches 304 may rotate in response. Further, for example, when the first arch 302 experiences a force, the first canopy wing 118 may rotate in response. Similarly, for example, when the second arch 304 experiences a force, the second canopy wing 120 may rotate in response. In some examples, the first arch 302 and the second arch 304 may rotate in opposite directions and/or the same direction. This rotation allows a user to adjust the angle of the canopy 116, adjust the amount of canopy 116 coverage or to collapse the canopy 116 entirely. However, in other examples, one of the first arch 302 or the second arch 304 may be stationary relative to the other arch within the canopy rotation structure 124 such that only one arch rotates while the other remains stationary. In embodiments with the central arch 402, the central arch 402 may remain stationary while the first arch 302 and/or the second arch 304 may rotate relative to the central arch 402.

The canopy rotation structures 124 may be removably coupled to the frame of the child transport product 100, such as to the first frame portion 102 and/or the second frame portion 104. In embodiments with the central arch 402 (such as those shown in FIGS. 4A-4C), each central arch 402 may couple to the first side 110 and the second side 112 of the child transport product 100. In these examples, the central arch 402 is connected to a post 404 extending away from the canopy rotation structure 124. In these examples, the post 404 may be received by a corresponding slot on the frame, such as on the first frame portion 102 or the second frame portion 104. The post 404 may be inserted into the slot and secured into place using securing mechanisms such as snap fits, spring loaded pins, sliding connections, a combination of these, and the like. In other examples, the post 404 may be configured to engage an additional structure attached to the frame. In embodiments without the central arch 402, the first arch 302 and the second arch 304 may be removably coupled to the frame by an additional structure attached to the frame that such that the first arch 302 and the second arch 304 are attached to the frame while remaining rotatable to each other.

The first arch 302 and the second arch 304 may take a variety of forms. As shown in FIGS. 4A-4C, the first arch 302 and the second arch 304 are circular in shape. In other embodiments, the first arch 302 and the second arch 304 may be any shape with at least a rounded portion such that rotation of the first wing 118 and the second wing 120 can occur. For example, the first arch 302 and the second arch 304 may be ovals, half circles, circles, and the like. The first arch 302 and the second arch 304 may be composed of a variety of materials, such as metal, alloy, plastic, wood, and/or a combination of these.

In some embodiments, the canopy rotation structures 124 each have an outer wall 405 forming an outer surface of the canopy rotation structure 124 and facing away from the opening 204, and an inner wall 410 opposite the outer wall 405 and defining the opening 204. The outer wall 405 may be formed by the first arch 302, the second arch 304, and in embodiments where present, the central arch 402. The inner wall 410 is defined by the first arch 302, the second arch 304, and the central arch 304 where present, but in other aspects, the inner wall 410 may be defined by the first arch 302 only, the second arch 304 only, or the first arch 302 and second arch 304. Further, in some aspects, the inner wall 410 may be a separate component secured to one of the first arch 302, the second arch 304, or the central arch 402.

The canopy rotation structures 124 also have a first side wall 406 extending between the outer wall 405 and the inner wall 410 and generally facing away from the second arch 304. The first side wall 406 may be an integrated component of the first arch 302, or it may be a separate component that couples to the first arch 302. For example, the first side wall 406 may removably couple to the first arch 302 via sliding connections, snap fits, and the like. It may be desirable to remove the first side wall 406 to access attachment points between the first arch 302 and the second arch 304, such as for repair or maintenance. In some embodiments, the first side wall 406 is a concave surface such that it caves in towards the inner wall 410, or a convex surface rounding away from the inner wall 410, such as to provide a more comfortable grip for the user. The first side wall 406 may have a tapered portion 408. In these examples, the tapered portion 408 at least partially tapers inward toward the inner wall 410 such that the thickness of the canopy rotation structure 124 (i.e., between the first side wall 406 and the second side wall 407) may be greater closer to the outer wall 405 than the inner wall 410. The surface of the first side wall 406 may be composed of metal, alloy, plastic, wood, or the like. In some embodiments, the canopy rotation structures 124 may have a second side wall 407 extending between the outer wall 405 and the inner wall 410 and generally facing away from the first arch 302. The second side wall 407 may be defined by the second arch 304 or formed of a separate structure secured to the second arch 304. In some aspects, the second side wall 407 has similar shape and construction as the first side wall 406 of the first arch 302, such as the configuration shown in FIG. 4B. For example, the second side wall of the second arch 304 may similarly have a convex surface, concave surface, and/or a tapered portion.

The inner wall 410 may extend at least partially into the first arch 302, and in some examples, between both the first arch 302 and the second arch 304 (i.e., where the opening 204 is a through hole). In embodiments with the central arch 402, the inner wall 410 may wholly or partially extend into the central arch 402. In some examples, the shape of the inner wall 410 may be at least partially cylindrical and correspond with the shape of the outer wall 405, such as the configuration shown in FIG. 4A, or it may be another shape, such as a rectangular prism, triangular prism, pentagonal prism, and the like such that the inner wall 410 does not correspond with the shape of the outer wall 405. For example, in some embodiments, the outer wall 405 may be at least partially cylindrical in shape and the inner wall 410 may be a triangular prism, which does not correspond to the shape of the outer wall 405, rather than a cylindrical prism, which would correspond to the shape of the outer wall 405, as shown in FIG. 4A.

The shape of the opening 204 may be defined by the inner wall 410 of the canopy rotation structure 124. For example, if the inner wall 410 is cylindrical, the shape of the opening 204 may likewise be cylindrical, and if the inner wall 410 is a triangular prism, the shape of the opening 204 may likewise be a triangular prism. In embodiments where the opening 204 is a through hole, as shown in FIGS. 4A-4C, the inner wall 410 fully extends between through the first arch 302 and the second arch 304 such that each of the first arch 302 and the second arch 304 define an entrance into the opening 204. In other embodiments, such as those where the opening 204 is an indentation, the inner wall 410 may extend partially or wholly into the first arch 302 and/or partially or wholly into the second arch 304, and/or partially or wholly into the central arch 402 but not wholly through the first arch 302, the second arch 304, and central arch 402.

The canopy rotation structures 124 may have an outer diameter as defined by the outer wall 405, and the opening 204 may have an inner diameter as defined by the inner wall 410. The outer and inner diameters may be a variety of values. The inner diameter is smaller than the outer diameter but large enough so that the size of the opening 204 is suitable to receive at least a portion of a user's grasp. For example, the inner diameter may be a size so that the opening 204 is suitable to receive at least two fingers of a user. The inner diameter may be within a range of about 30 millimeters to about 100 millimeters in some embodiments, within a range of about 40 millimeters to about 70 millimeters in other embodiments, and within a range of about 45 millimeters to about 60 millimeters in other embodiments. In one example, the inner diameter is about 50 millimeters. In some examples, the inner diameter is at least 50 millimeters. The outer diameter may be between within a range of about 60 to about 150 millimeters in some embodiments, within a range of about 75 millimeters to about 95 millimeters in other embodiments, and within a range of about 80 millimeters to about 90 millimeters in other embodiments. In one example, the outer diameter is about 86.5 millimeters.

In some embodiments, such as the one shown in FIGS. 4A-4C, the opening 204 may be a through hole such that the opening 204 provides a complete passageway from an outer side to an inner side of the canopy rotation structures 124. In these embodiments, the opening 204 can receive a user's grasp such that the user's fingers may enter the opening 204 through the first side wall 406 and extend through and at least partially exit the opening 204 through the second side wall 407 when grasping the canopy rotation structures 124. In other embodiments, the opening 204 may not be a through hole such that the user's fingers would extend through one of the first side wall 406 or the second side wall 407 but not the other when grasping the canopy rotation structures 124.

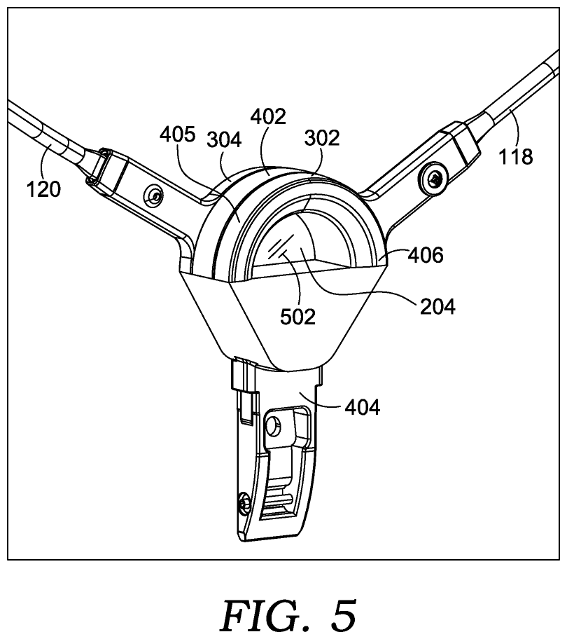

Turning now to FIG. 5, some embodiments of the canopy rotation structures 124 include an opening 204 that is an indentation rather than a through hole such that the inner wall 410 extends only partially through the canopy rotation structures 124 before reaching a back wall 502. The back wall 502 may be defined by one of the arches 302, 304, or 402 or another structure. In these embodiments, the entrance to the opening 204 may be through the first arch 302 or the second arch 304. In embodiments with the entrance of the opening 204 through the first arch 302, the opening 204 may extend partially or wholly through the first arch 302 before reaching the back wall 502. In some of these embodiments with the central arch 402, the opening 204 may extend partially or wholly through the central arch 402 before reaching the back wall 502. In some of these embodiments, the opening 204 may extend partially through the second arch 304 before reaching the back wall 502. In embodiments with the entrance of the opening 204 through the second arch 304, the opening 204 may extend partially or wholly through the second arch 304 before reaching the back wall 502. In some of these embodiments with the central arch 402, the opening 204 may extend partially or wholly through the central arch 402 before reaching the back wall 502. In some of these embodiments, the opening 204 may extend partially through the first arch 302 before reaching the back wall 502.

In embodiments where the opening 204 is closed by the back wall 502 and the entrance to the opening 204 is through the first arch 302, the opening 204 faces away from the other canopy rotation structure 124. In this configuration, a user may grasp the first side wall 406 and inner wall 410 of each canopy rotation structure 124 to grasp the canopy rotation structures 124 when using the canopy rotation structure 124 to move the frame or a portion of the frame of the child transport product 100. In other embodiments where the opening 204 is closed by the back wall 502 and the entrance to the opening 204 is through the second arch 304, the opening 204 faces towards the other canopy rotation structure 124.

The following clauses represent example embodiments of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A canopy configured to be attached to a child transport product comprising: a first and a second canopy rotation structures, each comprising a first arch and a second arch, each of the first arches are rotatable relative to the respective second arch, wherein the first and the second canopy rotation structures each have an opening configured for grasping, each of the openings being at least partially defined by the respective first arch; a first canopy wing extending between each of the first arches; and a second canopy wing extending between each of the second arches.

Clause 2. The canopy of clause 1, wherein each of the first and the second canopy rotation structures further comprise a central arch, wherein each of the central arches are positioned between the respective first arch and the respective second arch, wherein each of the central arches are configured to be attached to the child transport product.

Clause 3. The canopy of clauses 1 or 2, wherein each of the openings are at least partially defined on a first side by a first side wall of the respective first arch, wherein each of the first side walls at least partially tapers in towards the respective openings.

Clause 4. The canopy of clause 3, wherein each first side wall comprises a concave surface.

Clause 5. The canopy of any of clauses 1 through 4, wherein the first arch of the first canopy rotation structure faces away from the second canopy rotation structure and wherein the first arch of the second canopy rotation structure faces away from the first canopy rotation structure.

Clause 6. The canopy of any of clauses 1 through 5, wherein each of the first arches and the second arches are contiguously arranged in a horizontal orientation.

Clause 7. The canopy of any of clauses 1 through 6, wherein the first and second canopy wings comprise a textile portion at least partially extending between the first and second canopy wings.

Clause 8. A canopy configured to be attached to a child transport product comprising: a first and a second canopy rotation structures, each comprising a first arch and a second arch, each of the first arches are rotatable relative to the respective second arch, wherein the first canopy rotation structure has an opening configured for grasping, the opening being at least partially defined by the first arch of the first canopy rotation structure; a first canopy wing extending between each of the first arches; and a second canopy wing extending between each of the second arches.

Clause 9. The canopy of clause 8, wherein the opening comprises a circle.

Clause 10. The canopy of clauses 8 or 9, wherein the opening comprises a through hole extending through the both the first arch and the second arch of the first canopy rotation structure.

Clause 11. The canopy of any of clauses 8 through 10, wherein the opening comprises an indentation extending at least partially through the first arch.

Clause 12. The canopy of any of clauses 8 through 11, wherein the first arch of the first canopy rotation structure faces away from the second canopy rotation structure.

Clause 13. The canopy of any of clauses 8 through 12, wherein the inner diameter of the opening is at least 50 millimeters.

Clause 14. A child transport product comprising: a child transport frame defining a first side and a second side, the frame coupled to wheels; a first and a second canopy rotation structures, each comprising a first arch and a second arch, each of the first arches are rotatable relative to the respective second arches, wherein the first and the second canopy rotation structure each have an opening configured for grasping, each of the openings being at least partially defined by the respective first arch, wherein the first canopy rotation structure attaches to the first side and the second canopy rotation structure attaches to the second side; a first canopy wing extending between each of the first arches; and a second canopy wing extending between each of the second arches.

Clause 15. The child transport product of clause 14, wherein each of the openings comprise a through hole extending through the respective first and second arches.

Clause 16. The child transport product of clauses 14 or 15, wherein the child transport frame comprises a first frame portion movable relative to a second frame portion.

Clause 17. The child transport product of any of clauses 14 through 16, wherein each of the first and the second canopy rotation structures further comprise a central arch, wherein each of the central arches are positioned between the respective first and second arches, wherein the central arch of the first canopy rotation structure attaches to the first side, and wherein the central arch of the second canopy rotation structure attaches to the second side.

Clause 18. The child transport product of any of clauses 14 through 17, wherein each of the openings are at least partially defined on a first side by a first side wall of the respective first arch, wherein each of the first side walls at least partially taper in towards the respective opening.

Clause 19. The child transport product of any of clauses 14 through 18, wherein the first arch of the first canopy rotation structure faces away from the second canopy rotation structure and wherein the first arch of the second canopy rotation structure faces away from the first canopy rotation structure.

Clause 20. The child transport product of any of clauses 14 through 19, wherein each of the first and second canopy rotation structures are removably coupled to the child transport frame.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A canopy configured to be attached to a child transport product, the canopy comprising:
a first and a second canopy rotation structures, each comprising a first arch and a second arch, each of the first arches are rotatable relative to the respective second arch, wherein the first and the second canopy rotation structures each have an opening configured for grasping, each of the openings being at least partially defined by the respective first arch;
a first canopy wing extending between each of the first arches; and
a second canopy wing extending between each of the second arches.

2. The canopy of claim 1, wherein each of the first and the second canopy rotation structures further comprise a central arch, wherein each of the central arches are positioned between the respective first arch and the respective second arch, wherein each of the central arches are configured to be attached to the child transport product.

3. The canopy of claim 1, wherein each of the openings are at least partially defined on a first side by a first side wall of the respective first arch, wherein each of the first side walls at least partially tapers in towards the respective openings.

4. The canopy of claim 3, wherein each first side wall comprises a concave surface.

5. The canopy of claim 1, wherein the first arch of the first canopy rotation structure faces away from the second canopy rotation structure and wherein the first arch of the second canopy rotation structure faces away from the first canopy rotation structure.

6. The canopy of claim 1, wherein each of the first arches and the second arches are contiguously arranged in a horizontal orientation.

7. The canopy of claim 1, wherein the first and second canopy wings comprise a textile portion at least partially extending between the first and second canopy wings.

8. A canopy configured to be attached to a child transport product, the canopy comprising:
a first and a second canopy rotation structures, each comprising a first arch and a second arch, each of the first arches are rotatable relative to the respective second arch, wherein the first canopy rotation structure has an opening configured for grasping, the opening being at least partially defined by the first arch of the first canopy rotation structure;
a first canopy wing extending between each of the first arches; and
a second canopy wing extending between each of the second arches.

9. The canopy of claim 8, wherein the opening comprises a circle.

10. The canopy of claim 8, wherein the opening comprises a through hole extending through the both the first arch and the second arch of the first canopy rotation structure.

11. The canopy of claim 8, wherein the opening comprises an indentation extending at least partially through the first arch.

12. The canopy of claim 8, wherein the first arch of the first canopy rotation structure faces away from the second canopy rotation structure.

13. The canopy of claim 8, wherein the inner diameter of the opening is at least 50 millimeters.

14. A child transport product comprising:
a child transport frame defining a first side and a second side, the frame coupled to wheels;
a first and a second canopy rotation structures, each comprising a first arch and a second arch, each of the first arches are rotatable relative to the respective second arches, wherein the first and the second canopy rotation structure each have an opening configured for grasping, each of the openings being at least partially defined by the respective first arch, wherein the first canopy rotation structure attaches to the first side and the second canopy rotation structure attaches to the second side;
a first canopy wing extending between each of the first arches; and
a second canopy wing extending between each of the second arches.

15. The child transport product of claim 14, wherein each of the openings comprise a through hole extending through the respective first and second arches.

16. The child transport product of claim 14, wherein the child transport frame comprises a first frame portion movable relative to a second frame portion.

17. The child transport product of claim 14, wherein each of the first and the second canopy rotation structures further comprise a central arch, wherein each of the central arches are positioned between the respective first and second arches, wherein the central arch of the first canopy rotation structure attaches to the first side, and wherein the central arch of the second canopy rotation structure attaches to the second side.

18. The child transport product of claim 14, wherein each of the openings are at least partially defined on a first side by a first side wall of the respective first arch, wherein each of the first side walls at least partially taper in towards the respective opening.

19. The child transport product of claim 14, wherein the first arch of the first canopy rotation structure faces away from the second canopy rotation structure and wherein the first arch of the second canopy rotation structure faces away from the first canopy rotation structure.

20. The child transport product of claim 14, wherein each of the first and second canopy rotation structures are removably coupled to the child transport frame.
